(19) United States
(12) Patent Application Publication
(10) Pub. No.: US 2022/0314105 A1
(43) Pub. Date: Oct. 6, 2022

(54) THE WHEEL LIGHTING SYSTEM FOR PERSONAL MOBILITY DEVICES

(71) Applicants: Petr Petrovich Koshel, Pyatigorsk (RU); Alexander Alexandrovich Logvinov, Taganrog (RU)

(72) Inventors: Petr Petrovich Koshel, Pyatigorsk (RU); Alexander Alexandrovich Logvinov, Taganrog (RU)

(21) Appl. No.: 17/546,104

(22) Filed: Dec. 9, 2021

(30) Foreign Application Priority Data
Apr. 6, 2021 (RU) 2021109504

(51) Int. Cl. A63C 17/26; B62K 3/00

(52) U.S. Cl. CPC A63C 17/26; B62K 3/002; A63C 2203/14

(57) ABSTRACT

This technical solution relates to the field of Personal Mobility Devices (PMD) equipped with a Wheel Lighting System. A personal mobility device (PMD) containing wheels made of a substance containing photoluminophore, a wheel lighting system that contains at least one source of UV-light connected to a battery, a controlling device which activates the source of UV-light, wherein at least one source of UV-light is installed in such a way that enables the illumination of at least a part of the wheel.

### PRIOR ART

This technical solution refers to the field of Personal Mobility Devices (PMD) equipped with the Wheel Lighting System (WLS).

### BACKGROUND

Currently, the usage of WLS is a well-known solution for PMD (such as roller-skates, skateboards, scooters, mono-wheels, etc.). It is usually based on the integration of energy generators and sources of light into a wheel hub.

The example of that solution could be seen in patent RU 2237340 C2 (TELTEC CO., LTD. (KR), Sep. 27, 2004). The main disadvantages of this approach are: a) generation of energy creates certain physical resistance for wheels to spin; b) the whole construction of a wheel with an energy generating hub built-in is relatively complicated and not much robust. The lighting system could break down due to vibration or after a user's jump.

Another example is the following: the Hyper Concrete Glow wheels (https://www.skatepro.ru/342-23945.htm), which are made of a substance containing photoluminophore (photoluminescent phosphor). Such wheel can accumulate light energy and emit it for some time afterwards. These wheels are simple in production and do not create any physical resistance for movement of PMD. But the effect of the glow does not last long and fades relatively quickly.

### SUMMARY

Accordingly, it is an object of this invention to make it possible to solve the technical problem of creating a new effective principle of illumination of PMD wheels, devoid of the disadvantages inherent in solutions known from the prior art.

The main technical effect is to enhance the efficiency of the WLS by ensuring that PMD wheels' backlighting is performed without the physical resistance of wheels during movement. That is achieved by the usage of photoluminophore wheels which are backlighted by sources of ultraviolet (UV, black-light) light installed on a PMD body (frame).

The additional technical effect of the WLS is the improvement of the robustness of the system in general. The effect is made possible by excluding the usage of complicated parts, such as built-in energy generators in a wheel hub and by installing the sources of UV-light on a PMD frame, not inside the wheel.

The desirable technical effect is achieved by the installation of WLS for PMD which must have: a) a PMD with the installed source of UV-light (at least one unit), b) the controlling device for activating/deactivating the source of UV-light, c) the wheels of a PMD must be made of a substance containing photoluminophore, d) at least one source of UV-light should be installed in a position that enables the backlighting at least a part of the wheel.

In one particular embodiment the PMD is a kick-scooter or roller-skates.

In another particular embodiment the source of UV-light is equipped with at least one UV-LED.

In another particular embodiment the controlling device is a controller or microcontroller.

In another particular embodiment the controlling device is activated by the control unit.

In another particular embodiment the control unit is a button or a switch.

In another particular embodiment WLS further comprising a wireless data transfer device connected to the controlling device.

In another particular embodiment the wireless data transfer device is selected from the group consisting of a Bluetooth device, a BLE device or a GSM device.

In another particular embodiment activation of the controlling device is performed by an external device via wireless connection.

In another particular embodiment the external device is selected from the group consisting of a smartphone, a tablet, a smart-watch or a smart-bracelet.

In another particular embodiment the controlling device provides multiple lighting modes of the source of UV-light.

In another particular embodiment the source of UV-light is installed in a water resistant and dust proof case.

In another particular embodiment WLS further comprising a motion sensor connected to the controlling device, wherein the motion sensor is activated when PMD is moving.

### DESCRIPTION OF THE DRAWINGS

FIG. 1A-1B show the examples of Personal Mobility Device (PMD) with the Wheel Lighting System (WLS).

FIG. 2 shows an example of installation of the sources of UV-light into the protective cases.

FIG. 3 shows a basic scheme of the components' interconnection.

FIG. 4 shows an example of activation of illumination with the help of external device.

FIG. 5A-5D show the examples of installation of the sources of UV-light on PMD's body (frame).

### DESCRIPTION OF THE INVENTION

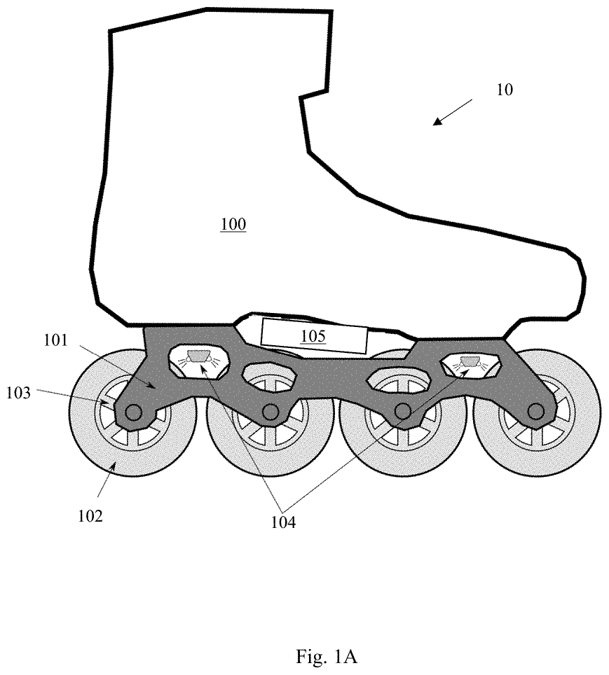

FIG. 1A shows an example of a PMD (10) which represents a roller-skate containing a boot (100), a frame (101), a wheel (102) with a hub (103), the sources of UV-light (104) and a battery (105). The sources of UV-light (104) are installed on a frame (101) in a way to backlight the wheels (102).

FIG. 1B shows an example of a PMD (10) which represents a scooter, containing the wheels (102) with the hubs (103), a body (frame) with the sources of UV-light (104) installed and a battery (105).

As a source of UV-light (104) there could be used ultraviolet light-emitting diodes (UV-LEDs). Their capability of emitting the lightwaves in the ultraviolet range offers the possibility of using a wide range of luminophores (phosphors) and results in a bright, colorful, fluorescent glowing of the wheel (102). The sources of UV-light could be narrow-aimed (focused) to backlight only a part of a wheel (102) because while the wheels (102) are spinning, the light energy distributes evenly within. The constant mode of backlighting of wheels (102) with the source of UV-light (104) is providing the long-term mode of backlight, depending on the capacity of a battery (105). A battery (105) could be designed as a rechargeable accumulator or power bank that could be mounted, for example, under the boot (100) or on a frame (101) or a body of PMD (10).

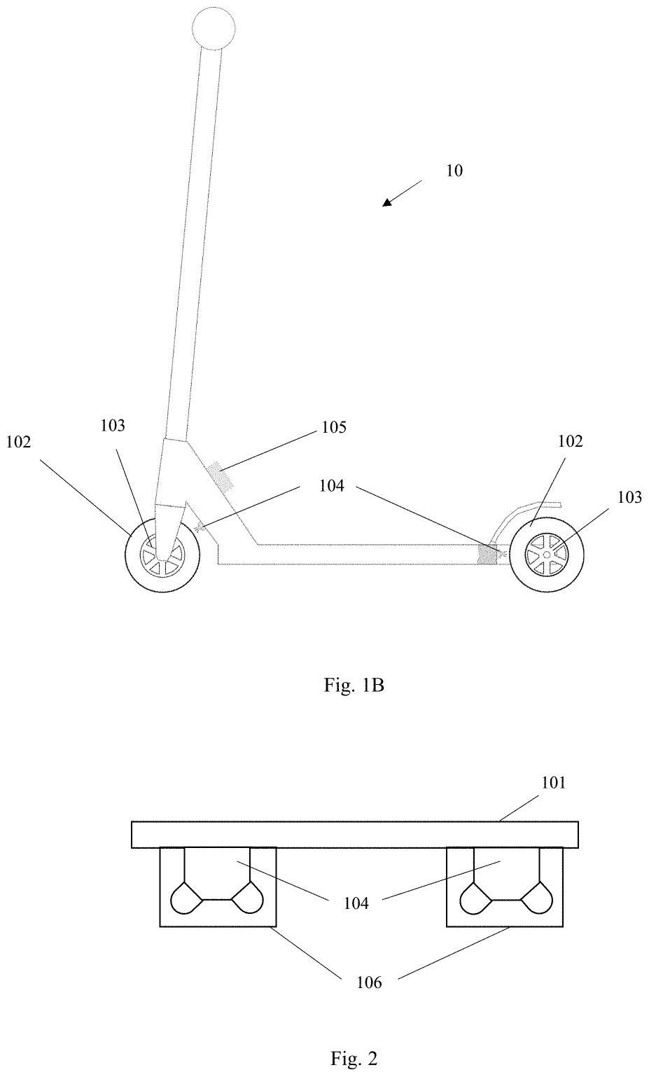

FIG. 2 shows an example of installation of the sources of UV-light (104) which are installed in a waterproof/dustproof case (106) and are mounted on a frame (101) of a PMD (10). The usage of the waterproof/dustproof cases (106) is reasonable for the purpose of securing a higher level of protection of the sources of UV-light (104) and lowering chances of causing a physical damage during usage of PMD (10).

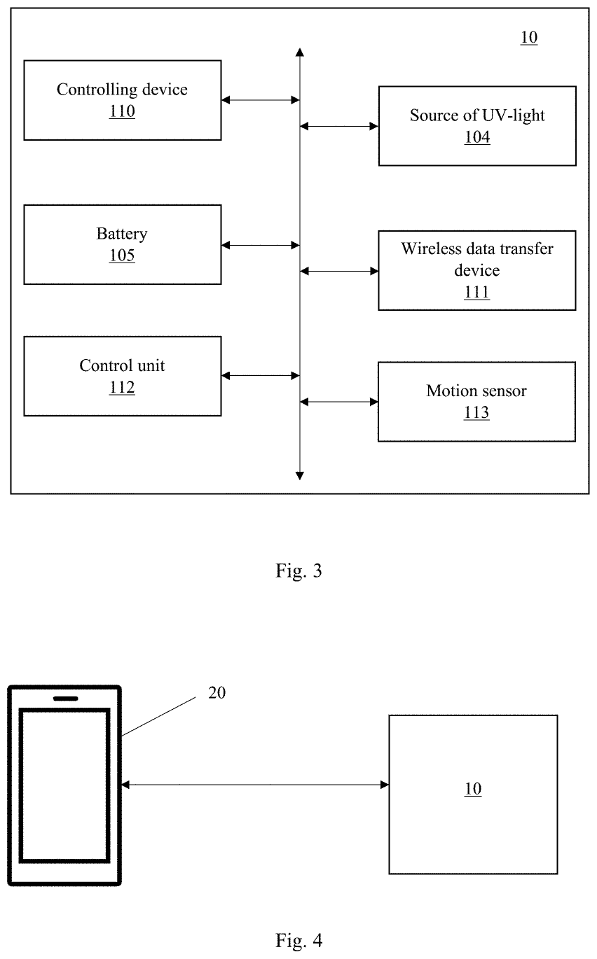

FIG. 3 shows a basic possible scheme of the components' interconnection. The control of backlighting, particularly, the activation/deactivation of the sources of UV-light (104), is held with the help of the controlling device (110) mounted on a PMD (10). The controlling device (110) could be designed as a controller or microcontroller. The controlling device (110) is connected to the battery (105) and the sources of UV-light (104) with the help of wires for transferring the control signals. The controlling device (110) could provide multiple lighting modes for the sources of UV-light (104), for example: constant or flashing modes, light intensity adjustment, etc.

The activation of the controlling device (110) could be performed in several ways; for example, with the help of a control unit (112). The control unit (112) could be designed as a button or a switch mounted on a PMD (10). Another way for the activation of the controlling device (110) could be the usage of a motion sensor (113) which transmits the control signal for the activation of the sources of UV-light (104) when PMD (10) starts moving.

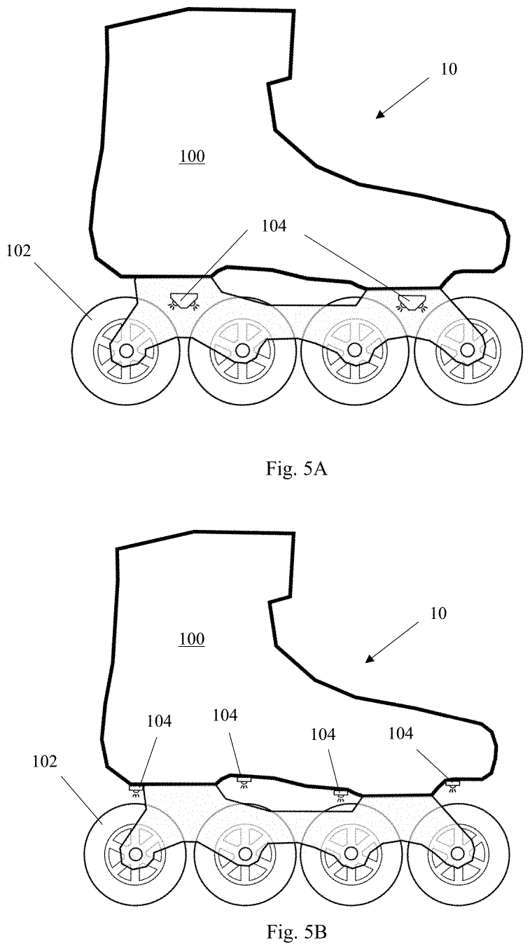

A PMD (10) could optionally have a wireless data transfer device (111) which task is to exchange data between the controlling device (110) and an external device (20) (FIG. 4). A wireless data transfer device could be designed as a Bluetooth device or a BLE device or a GSM device.

A multiple range of devices could be used as a wireless data transfer device (20). Among them: a smartphone, a tablet, a smart-watch, a smart-bracelet or any other existing or possible device which has an option of wireless data transfer for the controlling device (110) activation. The activation/deactivation could be implemented with the help of the special software, GUI (depending on a device).

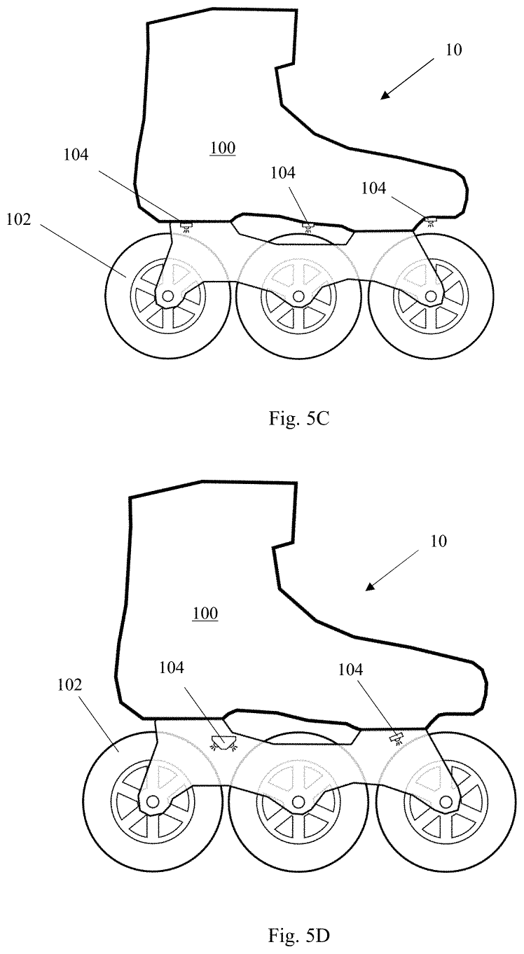

As shown on FIG. 5A-5D the ways of mounting (installing) of the sources of UV-light (104) may differ, depending on a type or a design of a PMD (10). For example, the sources of UV-light (104) could be installed on a frame (10) or under the boot (100) of a roller-skate, or on a body of a scooter.

The controlling device (110) could be assembled in a single body with other components, for example with a wireless data transfer device (20). The control unit (112) could be placed on a boot, on a frame, on a handlebar, on a body of a PMD (10), etc.

The number of the sources of UV-light (104) may vary, depending on the type of the PMD (10). For example, in the design of a roller-skate with two wheels, one source of UV-light (104) could be used, mounted in such a way that both wheels (part of wheels) (102) are backlighted. If the design of PMD (10) represents a scooter, at least two sources of UV-light (104) should be mounted, providing the presence of one unit near each wheel (102) to ensure proper backlighting. If the design of PMD (10) represents a skateboard two or four Sources of UV-light (104) could be used.

FIG. 5 shows that each source of UV-light (104) may contain one or several UV-LEDs mounted in such a way that proper backlighting of wheels (102) is provided.

The usage of backlighting of wheels (102) has an additional important effect: it provides the higher level of traffic security for the PMD user at night time. The wheels (102) are glowing constantly in contrast with common wheels with built-in generators which flash only while moving. That important effect increases PMD's user identification on the road and results in higher personal safety. The additional effect is the permanent illumination of the ground nearby the PMD.

While the present invention has been described with reference to a particular embodiment, it is not intended to illustrate or describe all of the equivalent forms or ways thereof. Also, the words and examples used are means of description rather than limitation, and various changes may be made without departing from the spirit or scope of the invention disclosed herein. Since numerous modifications and changes will readily occur to those skilled in the art, it is not desired to limit the invention to the exact construction and operation shown and described, and accordingly, all suitable modifications and equivalents may be resorted to, falling within the scope of the invention.

1. A personal mobility device (PMD) containing wheels made of a substance containing photoluminophore, a wheel lighting system that contains at least one source of UV-light connected to a battery, a controlling device which activates the source of UV-light, wherein at least one source of UV-light is installed in such a way that enables the illumination of at least a part of the wheel.

2. The PMD of claim 1, wherein the PMD is a kick-scooter or roller-skates.

3. The PMD of claim 1, wherein the source of UV-light is equipped with at least one UV-LED.

4. The PMD of claim 1, wherein the controlling device is a controller or microcontroller.

5. The PMD of claim 4, wherein the controlling device is activated by the control unit.

6. The PMD of claim 5, wherein the control unit is a button or a switch.

7. The PMD of claim 4, further comprising a wireless data transfer device connected to the controlling device.

8. The PMD of claim 7, wherein the wireless data transfer device is selected from the group consisting of a Bluetooth device, a BLE device or a GSM device.

9. The PMD of claim 7, wherein the activation of the controlling device is performed by an external device via wireless connection.

10. The PMD of claim 9, wherein the external device is selected from the group consisting of a smartphone, a tablet, a smart-watch or a smart-bracelet.

11. The PMD of claim 4, wherein the controlling device provides multiple lighting modes of the source of UV-light.

12. The PMD of claim 1, wherein the source of UV-light is installed in a water resistant and dust proof case.

13. The PMD of claim 4, further comprising a motion sensor connected to the controlling device, wherein the motion sensor is activated when PMD is moving.
